(19) United States
(12) Patent Application Publication
(10) Pub. No.: US 2025/0272073 A1
(43) Pub. Date: Aug. 28, 2025

(54) PROGRAM GENERATION METHOD, PROGRAM GENERATION DEVICE, AND STORAGE MEDIUM STORING PROGRAM GENERATION PROGRAM

(71) Applicant: DENSO CORPORATION, Kariya-city (JP)

(72) Inventors: Remma TAKEUCHI, Kariya-city (JP); Tatsuro KAWAKAMI, Kariya-city (JP)

(21) Appl. No.: 19/050,178

(22) Filed: Feb. 11, 2025

(30) Foreign Application Priority Data
Feb. 22, 2024 (JP) 2024-025178

(51) Int. Cl. G06F 8/41

(52) U.S. Cl. CPC G06F 8/433

(57) ABSTRACT

A program generation method includes acquiring a program, extracting functions within program code included in the program and a control flow, which is a call/return relationship of the functions, identifying a first function among the functions that has a high tampering likelihood in the control flow, identifying a second function among the functions that is reachable to the first function, determining a scope of application of control flow integrity (CFI) including the first function and the second function according to a type of the control flow, and inserting a processing instruction into the program code to execute the control flow correctly within the scope of application.

### CROSS REFERENCE TO RELATED APPLICATION

This application is based on Japanese Patent Application No. 2024-025178 filed on Feb. 22, 2024, the disclosure of which is incorporated herein by reference.

### TECHNICAL FIELD

The present disclosure relates to a program such as a user application composed of multiple modules, and more specifically, to a program generation method, a program generation device, a program generation program executable by the program generation method, a program generated by the program generation method, and an electronic control device in which the program generated by the program generation method is installed, which are resistant to buffer overflow attacks.

### BACKGROUND

A related art describes inserting processing instructions into the program code to correctly execute the control flow based on the importance of functions, thereby using CFI technology while suppressing the overhead of program execution without depending on the domain.

### SUMMARY

A program generation method includes acquiring a program, extracting functions within program code included in the program and a control flow, which is a call/return relationship of the functions, identifying a first function among the functions that has a high tampering likelihood in the control flow, identifying a second function among the functions that is reachable to the first function, determining a scope of application of control flow integrity (CFI) including the first function and the second function according to a type of the control flow, and inserting a processing instruction into the program code to execute the control flow correctly within the scope of application.

### BRIEF DESCRIPTION OF DRAWINGS

Objects, features and advantages of the present disclosure will become more apparent from the following detailed description made with reference to the accompanying drawings. In the drawings:

FIG. 1A and FIG. 1B are explanatory diagrams illustrating an overview of the overall configuration in each embodiment;

FIG. 2 is a flowchart of the program generation method common to the embodiments;

FIG. 3 is a configuration diagram showing the configuration of the program generation device in the first embodiment;

FIG. 4A to FIG. 4D are explanatory diagrams illustrating a specific example of the first information stored in the storage unit of the program generation device;

FIG. 5A to FIG. 5C are explanatory diagrams illustrating a specific example of the second information stored in the storage unit of the program generation device;

FIG. 6 is an explanatory diagram illustrating the operation of the extraction step of the program generation method or the extraction unit of the program generation device;

FIG. 7 is an explanatory diagram illustrating a first example of the operation of the first function identification step of the program generation method or the first identification unit of the program generation device;

FIG. 8 is an explanatory diagram illustrating a second example of the operation of the first function identification step of the program generation method or the first identification unit of the program generation device;

FIG. 9 is an explanatory diagram illustrating a third example of the operation of the first function identification step of the program generation method or the first identification unit of the program generation device;

FIG. 10 is an explanatory diagram illustrating a first example of the operation of the second function identification step of the program generation method or the second identification unit of the program generation device;

FIG. 11 is an explanatory diagram illustrating a second example of the operation of the second function identification step of the program generation method or the second identification unit of the program generation device;

FIG. 12 is an explanatory diagram illustrating a third example of the operation of the second function identification step of the program generation method or the second identification unit of the program generation device;

FIG. 13 is an explanatory diagram illustrating a first example of the operation of the step of determining the scope of application of CFI in the program generation method or the application scope determination unit of the program generation device;

FIG. 14 is an explanatory diagram illustrating a second example of the operation of the step of determining the scope of application of CFI in the program generation method or the application scope determination unit of the program generation device;

FIG. 15 is an explanatory diagram illustrating a third example of the operation of the step of determining the scope of application of CFI in the program generation method or the application scope determination unit of the program generation device;

FIG. 16 is an explanatory diagram illustrating a first example of the operation of the step of inserting processing instructions in the program generation method or the insertion unit of the program generation device;

FIG. 17 is an explanatory diagram illustrating a second example of the operation of the step of inserting processing instructions in the program generation method or the insertion unit of the program generation device; and

FIG. 18 is a configuration diagram showing the configuration of the program generation device in the second embodiment.

### DETAILED DESCRIPTION

A buffer overflow attack is executed by injecting a program created by an attacker into a memory of a running program, resulting in the control of the computer being hijacked. Specifically, the program injected by the attacker changes the return address placed on a stack, and control is transferred to the injected program, thereby hijacking the control of the computer.

Various solutions have been proposed to counter buffer overflow attacks. One such solution is Control Flow Integrity (CFI), which allows the attacker to modify the return address but detects the change before the computer's control is hijacked. In CFI, when a function calls or returns to another function in the program code, an ID (identifier) of the called or returned function is checked, and the call/return process is executed only if the ID of the called or returned function is permitted. However, using CFI presents challenges such as the time required for the check process during program execution and the difficulty of implementation on low-performance processors.

The inventors of the present disclosure have found that there is process that is prone to be tampered based on the structure of the program, and the range of the process varies depending on the type of control flow. The process does not necessarily align with the importance of the function realized by the program or the importance in the environment where the program is executed.

The present disclosure provides a program generation method, or the like that can suppress the overhead during program execution while using CFI technology.

According to one aspect of the present disclosure, a program generation method is provided. The method includes: acquiring a program; extracting functions within program code included in the program and a control flow, which is a call/return relationship of the functions; identifying a first function among the functions that has a high tampering likelihood in the control flow; identifying a second function among the functions that is reachable to the first function; determining a scope of application of control flow integrity (CFI) including the first function and the second function according to a type of the control flow; and inserting a processing instruction into the program code to execute the control flow correctly within the scope of application.

According to the program generation method, or the like of the present disclosure, by determining the scope of application of CFI according to the type of control flow, it is possible to suppress the overhead during program execution while using CFI technology. Thereby, it is possible to implement on low-performance processors.

Hereinafter, embodiments of the present disclosure will be described with reference to the drawings.

When there are multiple embodiments, the configurations disclosed in each embodiment are not limited to each embodiment alone and can be combined across embodiments. For example, the configuration disclosed in one embodiment may be combined with another embodiment. Additionally, the configurations disclosed in each of the multiple embodiments may be collected and combined.

### 1. Overview of the Overall Configuration of Each Embodiment

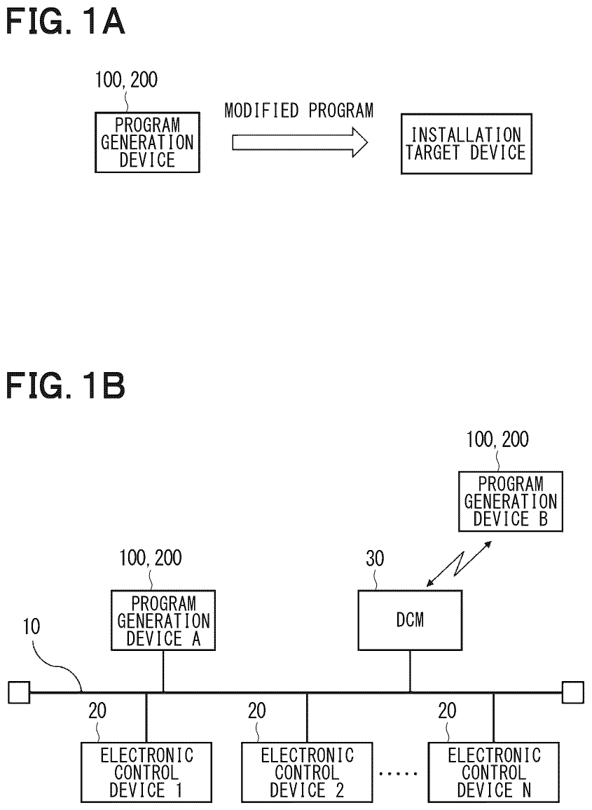

FIG. 1A and FIG. 1B illustrate an overview of the overall configuration in each embodiment. The program generation devices 100 and 200 in each embodiment analyze the program and output a modified program with processing instructions inserted into the program code. As shown in FIG. 1A, the modified program is installed in a target device, for example. Therefore, the program generation devices 100 and 200 are basically used at the time of building the program. The use of the target device is arbitrary. The installation location and network connection of the program generation devices 100 and 200 are also arbitrary.

An example of a target device for installation is an in-vehicle electronic control device (also referred to as a vehicular electronic control device). An electronic control system is constructed using the electronic control device in which the modified program is installed.

The program generation devices 100 and 200 in each embodiment can also be used to install the modified program in an electronic control device 20 of an already constructed electronic control system. FIG. 1B shows an electronic control system mounted on a vehicle. The network 10 of the electronic control system is connected to N (where N is an arbitrary natural number) electronic control devices 20, program generation devices 100 and 200, a data communication module (DCM) 30, and so on. The program generation devices 100 and 200 may be always connected to the network 10 via wired or wireless connections like the program generation device A, or they may be connected only when necessary using connectors and cables. Alternatively, the program generation devices 100 and 200 may be indirectly connected to the network 10 via wireless communication through the data communication module 30, either always or only when necessary, like the program generation device B.

The program generation method of each embodiment is executed by the program generation devices 100 and 200 shown in FIG. 1A and FIG. 1B. For example, a program executable by the program generation method of each embodiment is executed. The program generated by the program generation method is installed in a predetermined electronic control device 20 (corresponding to the “electronic control device”). Here, the “electronic control device” may be any electronic control device that constitutes the electronic control system. It may be a physically independent electronic control device or a virtualized electronic control device realized using virtualization technology. The electronic control device may be mounted on a mobile or stationary body.

In the case of FIG. 1B, the program generation devices 100 and 200 may be dedicated devices, but they may also be realized on a specific electronic control device 20. In this case, the installation destination of the generated program may be this specific electronic control device.

### 2. Common Operation of Each Embodiment (Program Generation Method)

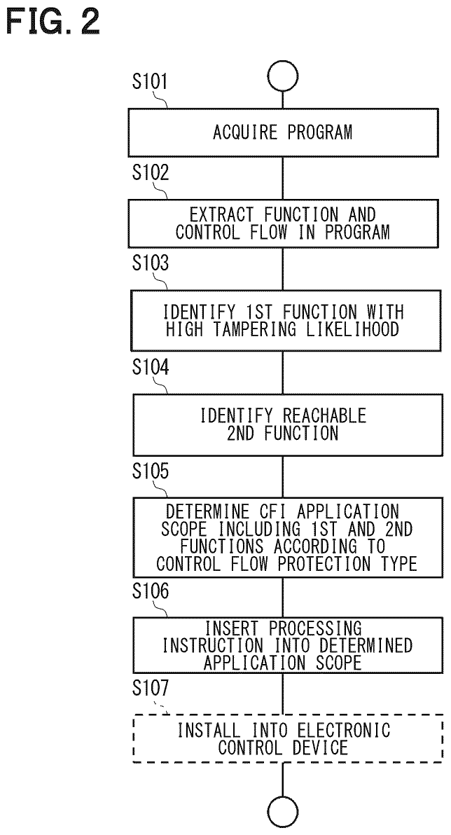

FIG. 2 is a flowchart illustrating the program generation method common to each embodiment. The configurations of the program generation device 100 and the program generation device 200, in which the program generation method is executed, will be described in a first embodiment and a second embodiment, respectively.

First, the original program, which is the target of the program generation method of the embodiment, is acquired (S101). The original program is, for example, a program such as a user application composed of multiple modules.

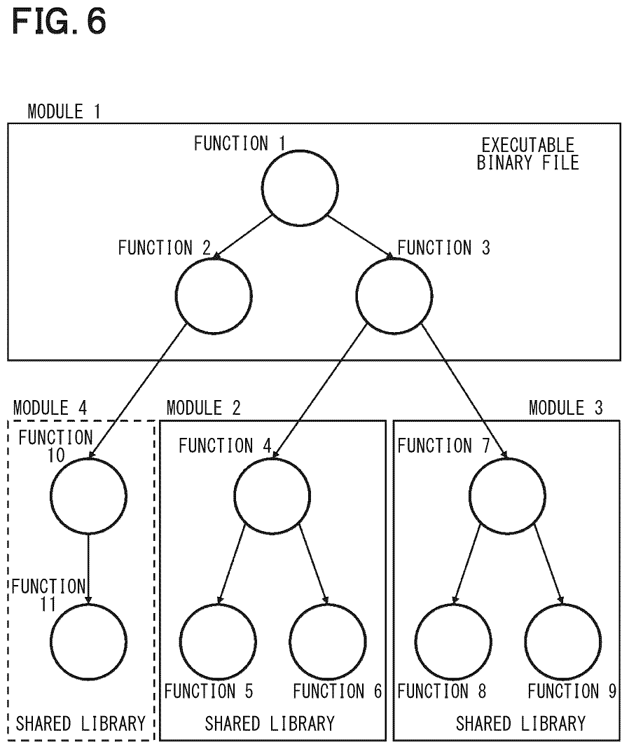

Next, the “functions” within the “program code” included in the program and the control flow, which is the “call/return” relationship of the functions, are extracted (S102). The details of the step of extracting functions and control flow will be described later in the first embodiment with reference to FIG. 6. Here, “program code” may be described in machine language, assembly language, or a high-level language. “Function” includes not only functions in the narrow sense but also what are called methods. “Function call” includes, for example, Forward Edge, that is, control flow transitions by branch instructions specifying the destination address, and indirect calls, that is, function calls via function pointers described in C/C++ source code. “Function return” includes, for example, Backward Edge, that is, operations that write back the return address recorded on the stack to the program counter, and function returns, that is, function returns described in C/C++ source code.

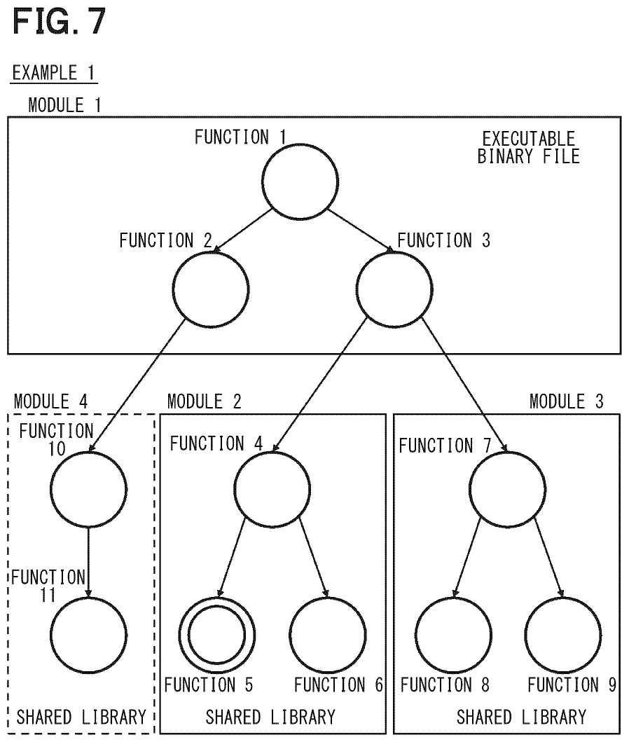

Next, among the extracted functions, a first function that has a “high tampering likelihood” in the control flow is identified (S103). The details of the step of identifying the first function will be described later in the first embodiment with reference to FIG. 7 to FIG. 9. Here, “high tampering likelihood” refers to processes that are highly likely to be used for tampering with the control flow based on the structure of the program. Examples include processes that rewrite a memory or addresses stored in a memory, causing the control flow transition destination to be rewritten, or processes that transition control by referring to memory addresses, which are key processes governing the control flow based on the program's structure. In any case, these are processes where the control flow can be evaluated to change if rewritten. “High tampering likelihood” can also be referred to as processes with a high risk of being attacked.

Examples of processes with a high tampering likelihood include the following (A) to (D). (A) is an example of processes that rewrite a memory or addresses in a memory, (B) is an example of processes that call modules outside the scope of CFI, (C) is an example of processes that transition control by referring to memory addresses, and (D) is an example of processes where their own address is obtained.
(A) Processes that include writing operations to memory from external input data. More specifically, (A) corresponds to calling (e.g., read ( ) function) specific APIs from sockets, files, or devices, and write operations to a memory (e.g., str instruction in ARM).
(B) Processes that call modules where CFI is not applied or cannot be applied.
(C) Processes that serve as the starting point for Forward Edge (e.g., function calls). More specifically, (B) corresponds to functions with indirect calls via function pointers.
(D) Functions where their own address is obtained. More specifically, (D) corresponds to processes placed at addresses stored in a memory as transition destination addresses.

One or more of the above (A) to (C) may be identified as functions with a high tampering likelihood. Additionally, processes with a high tampering likelihood other than (A) to (C) may also be used.

In this embodiment, as described later, CFI is applied to functions that have processes with a high tampering likelihood. The reasons for applying CFI to processes with a high tampering likelihood, focusing on (A) to (D), are as follows:
(A) In both Backward/Forward Edge cases, tampering with the control flow occurs when the values recorded in a memory are tampered with, that is, written;
(B) In both Backward/Forward Edge cases, it is unknown what operations will be performed by functions implemented in modules not protected by CFI. There may be a risk that a memory may be tampered with by functions implemented in unprotected modules;
(C) In the case of Forward Edge, function pointers can be rewritten to any process, and function pointers may exist in global data areas. Therefore, there may be a risk that an attacker may rewrite the value pointed to by the function pointer before executing an indirect call, initiating an attack. Forward Edge attacks occur by transitioning to the address of the tampered function pointer (a memory); and
(D) In the case of Forward Edge, there may be a risk of initiating an attack by rewriting the transition destination address.

When a first function cannot be identified among the extracted functions, that is, when there are no functions with a high tampering likelihood, the application of this program generation method is terminated.

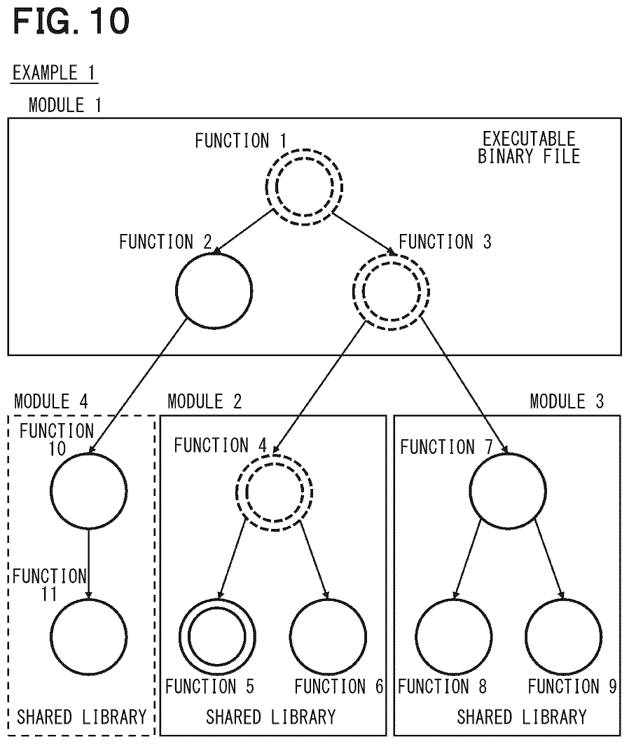

Next, among the extracted functions, a second function that is “reachable” to the first function identified in step S103 is further identified (S104). The details of the step of identifying the second function will be described later in Embodiment 1 with reference to FIG. 10 to FIG. 12. Here, “reachable” means that the first function can be executed directly or indirectly using function calls/returns.

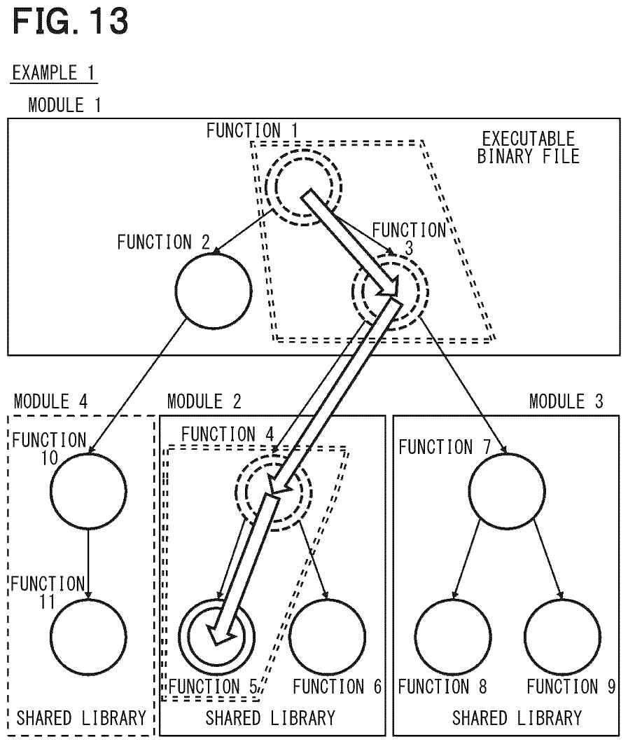

Next, “according to” the “type of control flow” of the function identified in step S102, the scope of application (also referred to as an application range) of CFI is determined (S105). The scope of application of CFI includes the first function identified in step S103 and the second function identified in step S104. In the embodiments described later, the scope of application of CFI is explained in two cases: a scope including only the first and second functions, and a scope including a module containing at least one of the first and second functions. However, other cases may also be set. For example, the scope may include all of the first functions and functions directly adjacent to the first functions among the second functions. In other words, not all second functions need to be included in the scope. The details of the step of determining the scope of application will be described later in the first embodiment with reference to FIG. 13 to FIG. 15. Here, “type of control flow” refers to control flows that can be distinguished when applying CFI technology. For example, control flows may be distinguished by the type of transition in the control flow. Examples include Forward Edge and Backward Edge. “According to” means that a direct or indirect correspondence is sufficient.

In the case of Forward Edge, for example, an attack using branch instruction such as call or jump instruction is prevented. And in the case of Backward Edge, an attack using return instruction is prevented. Thus, Forward Edge and Backward Edge differ in the type of control flow protection, that is, the target of protection.

Then, within the scope of application of CFI determined in step S105, a processing instruction to correctly execute the control flow is inserted into the program code (S106). Processing instructions include, for example, a check processing instruction that checks the ID of the called/returned function during function calls/returns, and a protection processing instruction that stores the return address in a secure area and executes the return process based on the return address stored in the secure area. The former is an example of processing instructions focusing on checking or verifying the control flow, and the latter is an example of processing instructions focusing on protecting the control flow.

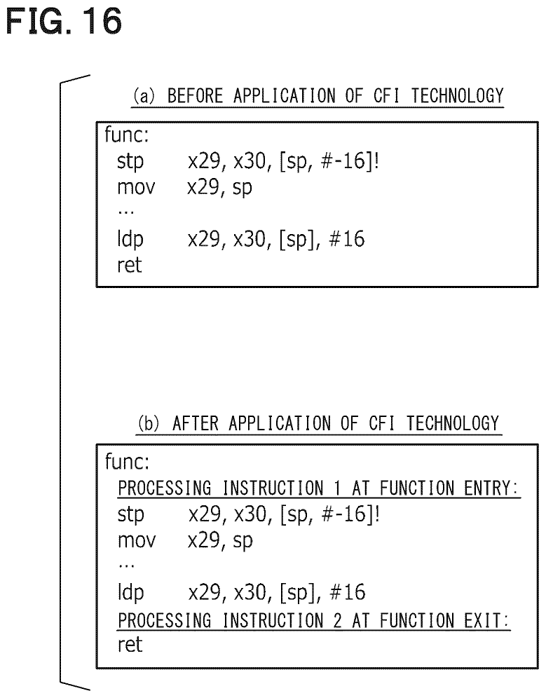

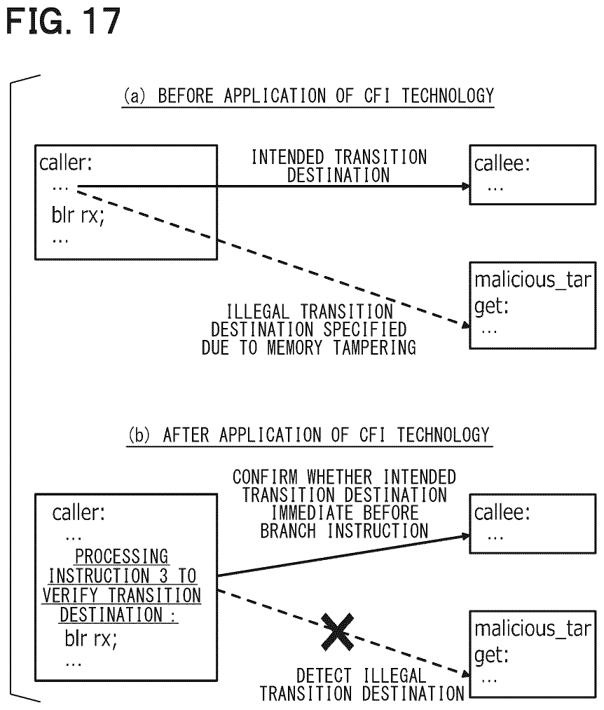

If the control flow extracted in step S102 is a Backward Edge, for example, a processing instruction to protect the return address is inserted at the entry and exit of the function. Details will be described later in the first embodiment with reference to FIG. 16. If the control flow extracted in step S102 is a Forward Edge, for example, a processing instruction to verify whether the transition destination is legitimate is inserted immediately before the branch instruction. Details will be described later in the first embodiment with reference to FIG. 17.

Optionally, the program including the program code with the inserted processing instructions may be written into, that is, installed in, the “electronic control device” (S107). For example, if steps S101 to S106 of the program generation method are executed in the program generation device 100 or the program generation device 200 described in FIG. 1A or FIG. 1B, the program including the program code with the inserted processing instruction is written into the electronic control device 20, which is the target of program installation.

As described above, FIG. 2 not only illustrates the program generation method executed by the program generation devices 100 and 200 but also shows the processing procedure of the program generation program executable by the program generation devices 100 and 200. The order of these processes is not limited to that shown in FIG. 2. That is, the order may be rearranged as long as there are no constraints such as a step requiring the result of a preceding step.

### 3. First Embodiment (Program Generation Device 100)

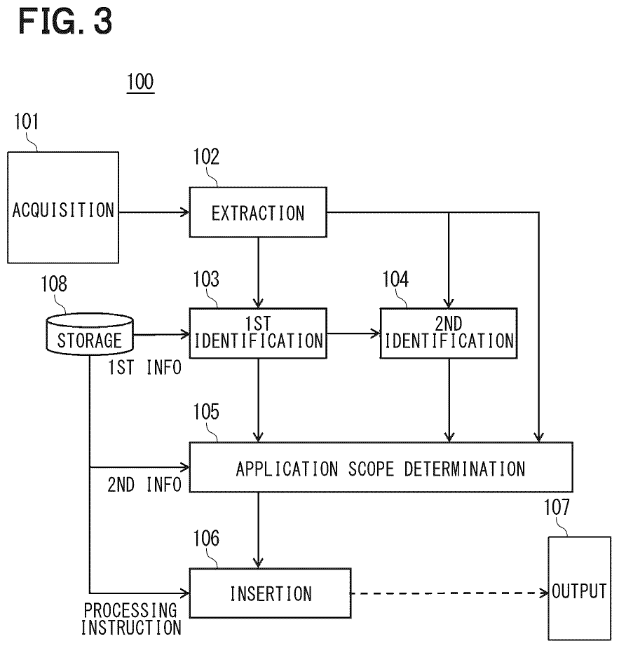

An example configuration of the program generation device 100 of this embodiment will be described with reference to FIG. 3. The program generation device 100 includes an acquisition unit 101, an extraction unit 102, a first identification unit 103, a second identification unit 104, an application scope determination unit 105, an insertion unit 106, an output unit 107, and a storage unit 108.

In the embodiment, the first information regarding processes with a high tampering likelihood in the control flow and the second information defining the control flow to which CFI is to be applied and the scope of functions to which CFI is to be applied are stored in advance in the storage unit 108 of the program generation device 100. In other words, the program generation device 100 of the embodiment can automatically generate a program including program code with inserted processing instructions using these pre-stored pieces of information.

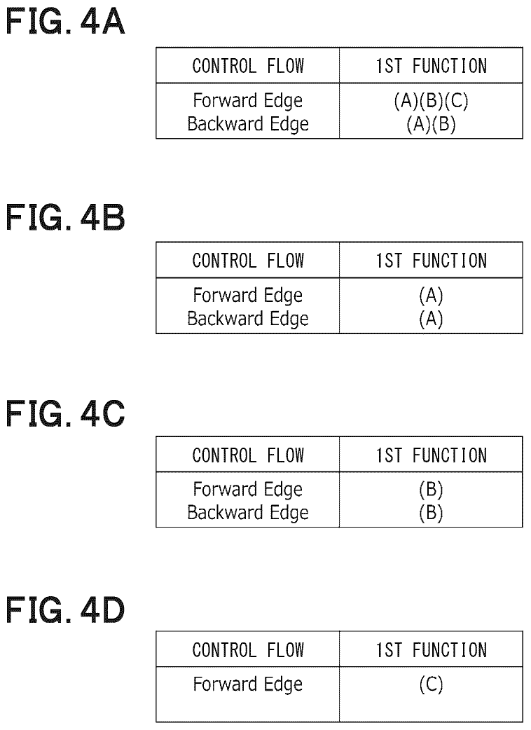

An example of the first information will be described with reference to FIG. 4A to FIG. 4D.

The first information includes processes (A) to (D) mentioned earlier, specifically:
(A) Processes that include writing operation to a memory from external input data;
(B) Processes that call a module where CFI is not applied or cannot be applied; and
(C) Processes that serve as a starting point for Forward Edge (e.g., call of a function).

FIG. 4A shows that in the control flow of Forward Edge in the program, functions (A), (B), and (C) are identified as the first functions, and in the control flow of Backward Edge, functions (A) and (B) are identified as the first functions. FIG. 4B shows that in the control flow of Forward Edge and Backward Edge in the program, function (A) is identified as the first function. FIG. 4C shows that in the control flow of Forward Edge and Backward Edge in the program, function (B) is identified as the first function. FIG. 4D shows that in the control flow of Forward Edge in the program, function (C) is identified as the first function. In this case, functions related to the control flow of Backward Edge are not identified as the first function.

Although (A) to (C) are described in FIG. 4A to FIG. 4D, specific instructions executing these processes may also be enumerated. Additionally, the first functions may be indicated without specifying the control flow. In this case, all enumerated functions are identified as the first functions regardless of the type of control flow.

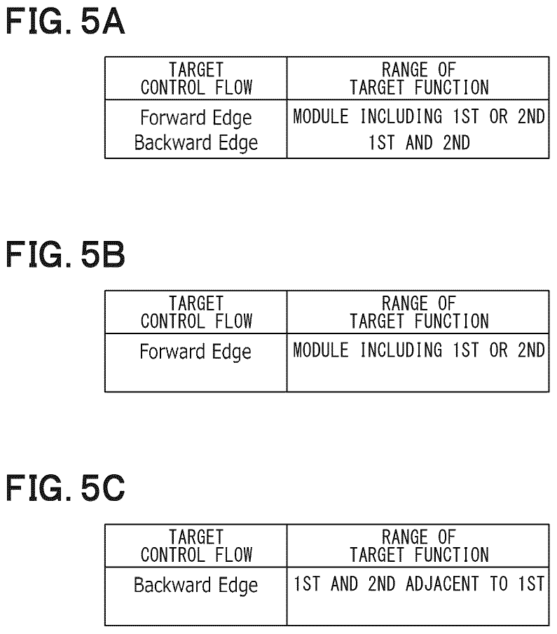

An example of the second information will be described with reference to FIG. 5A to FIG. 5C. FIG. 5A to FIG. 5C define the relationship between the control flow to which CFI is to be applied (referred to as target control flow in FIG. 5A to FIG. 5C) and the scope of functions to which CFI is to be applied (referred to as the scope of target functions in FIG. 5A to FIG. 5C). FIG. 5A shows that if the target control flow is Forward Edge, the scope of target functions includes all functions in the module containing at least one of the first or second functions, and if the target control flow is Backward Edge, the scope of target functions includes the first and second functions. FIG. 5B shows that if the target control flow is Forward Edge, the scope of target functions includes all functions in the module containing at least one of the first or second functions. In the case of FIG. 5B, the scope of target functions does not include the control flow of Backward Edge. FIG. 5C shows that if the target control flow is Backward Edge, the scope of target functions includes the first function and the second function adjacent to the first function.

The storage unit 108 may also store a processing instruction to be inserted by the insertion unit 106, in addition to the first and second information.

The acquisition unit 101 acquires the original program from an external source. As mentioned earlier, the original program is, for example, a program such as a user application composed of multiple modules. Examples of modules include an executable binary file, a static library, a dynamic library, or the like.

The extraction unit 102 extracts the functions within the program code included in the program acquired by the acquisition unit 101 and the control flow, which is the call/return relationship of the functions.

FIG. 6 is an explanatory diagram illustrating the operation of the extraction step of the program generation method or the extraction unit 102 of the program generation device 100, and an example of the result of extracting functions and control flow will be described with reference to FIG. 6. In FIG. 6, solid and dashed rectangles represent modules, corresponding to multiple modules within a user application. In the example shown in FIG. 6, module 1, which is an executable binary file, and modules 2 to 4, which are shared libraries are included. The module 4, represented by a dashed rectangle, is a module that is not protected or cannot be protected by CFI, such as a shared library for which the source code is not available. Each module has at least one function, and solid circles represent functions 1 to 11. The control flow, which is the call/return relationship of the functions, is indicated by solid arrows in FIG. 6.

Returning to FIG. 3, the first identification unit 103 identifies a function among the extracted functions that correspond to processes with a high tampering likelihood in the control flow as the first function. In this embodiment, the first identification unit 103 identifies the first function based on the first information stored in the storage unit 108. When multiple functions are extracted by the extraction unit 102, the first identification unit 103 determines whether each function corresponds to a process with a high tampering likelihood and identifies a function as the first function if a function corresponds to a process with a high tampering likelihood. The details of the step of identifying the first functions by the first identification unit 103 will be described with reference to FIG. 7 to FIG. 9.

In the example shown in FIG. 7, a function 5 of a module 2 includes a process that writes external input data to a memory. The first information stored in the storage unit 108 is assumed to be FIG. 4B. Since the function 5 corresponds to the process (A) of the first information stored in the storage unit 108, the first identification unit 103 identifies the function 5 as the first function. In FIG. 7, the first function identified is indicated by a solid double circle. In the following figures, the first functions are similarly indicated by solid double circles.

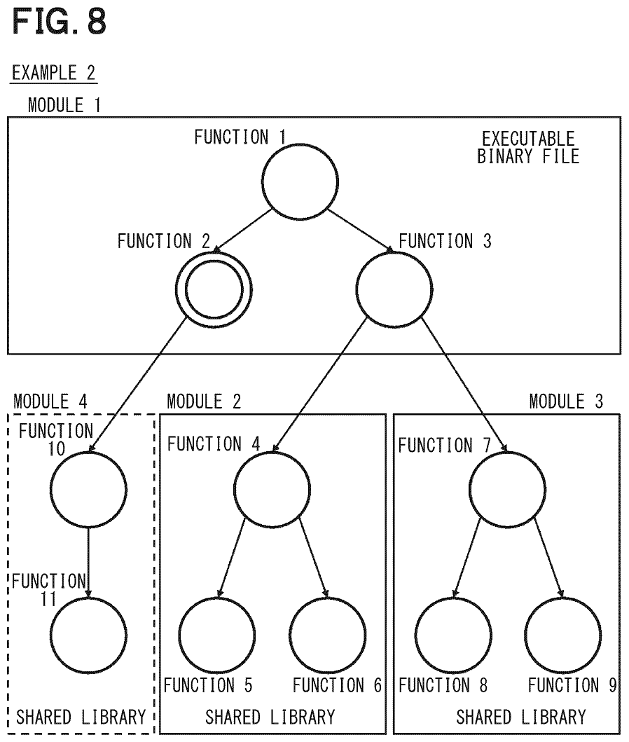

In the example shown in FIG. 8, a function 2 of a module 1 includes a process that calls a function 10 of a module 4, which is a module not protected by CFI. The first information stored in the storage unit 108 is assumed to be FIG. 4C. Since the function 2 corresponds to the process (B) of the first information stored in the storage unit 108, the first identification unit 103 identifies function 2 as the first function.

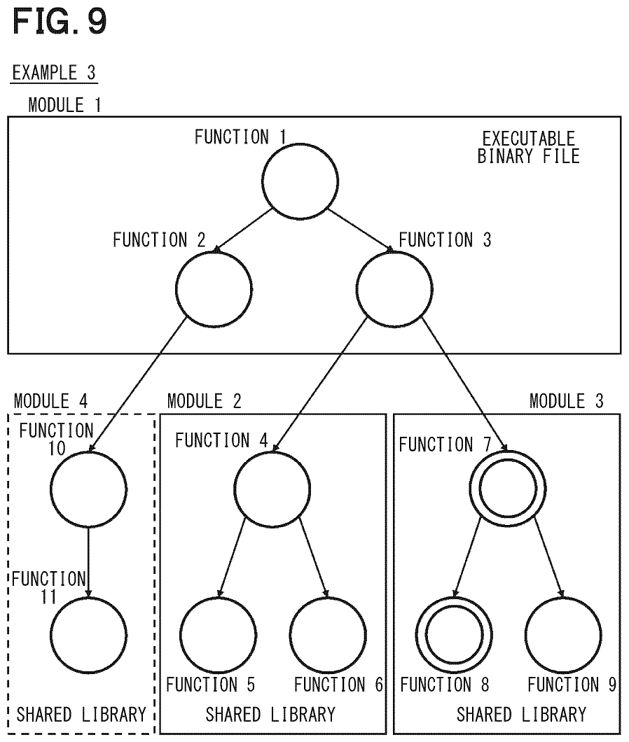

In the example shown in FIG. 9, a function 7 of a module 3 includes a function pointer used for indirect calls. The first information stored in the storage unit 108 is assumed to be FIG. 4D. Since the function 7 corresponds to the process (C) of the first information stored in the storage unit 108, the first identification unit 103 identifies the function 7 as the first function. Additionally, a function 8 of a module 3includes a process where its address is obtained. Since the function 8 corresponds to the process (C) of the first information stored in the storage unit 108, the first identification unit 103 identifies function 8 as the first function.

If the first information stored in the storage unit 108 is FIG. 4A, the first identification unit 103 identifies functions 2, 5, 7, and 8 as the first functions, as shown in FIG. 7 to FIG. 9.

Returning to FIG. 3, the second identification unit 104 identifies all functions among the extracted functions that are reachable to the first function identified by the first identification unit 103 as the second function. The details of the step of identifying the second function by the second identification unit 104 will be described with reference to FIG. 10 to FIG. 12.

In FIG. 10, the function reachable to a function 5, which is the first function shown in FIG. 7, is a function 4. A function reachable to the function is a function 3. A function reachable to the function 3 is a function 1. In this example, the second identification unit 104 identifies functions 1, 3, and 4, which are reachable to the first function 5, as the second functions. In FIG. 10, the second functions identified are indicated by dashed double circles. In the following drawings, the second functions are similarly indicated by dashed double circles.

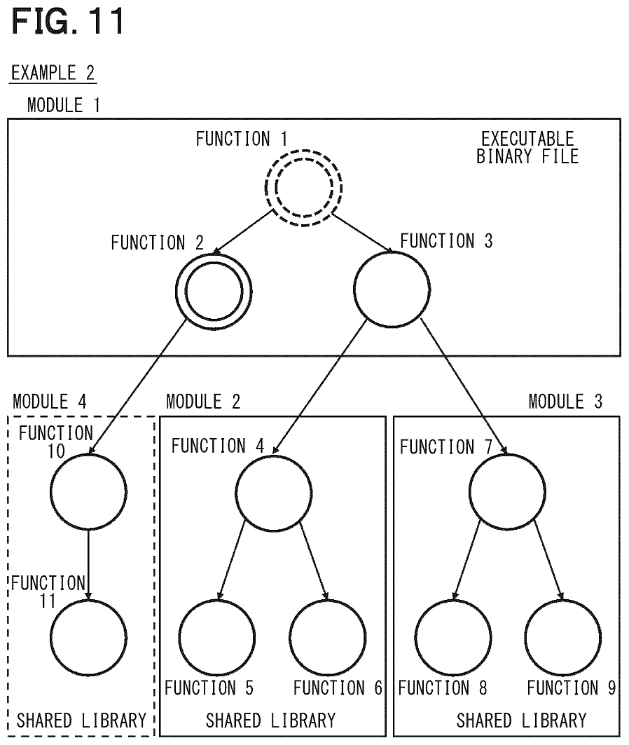

In FIG. 11, the function reachable to the function 2, which is the first function shown in FIG. 8, is a function 1. In this example, the second identification unit 104 identifies the function 1 reachable to the function 2, which is the first function, as the second function.

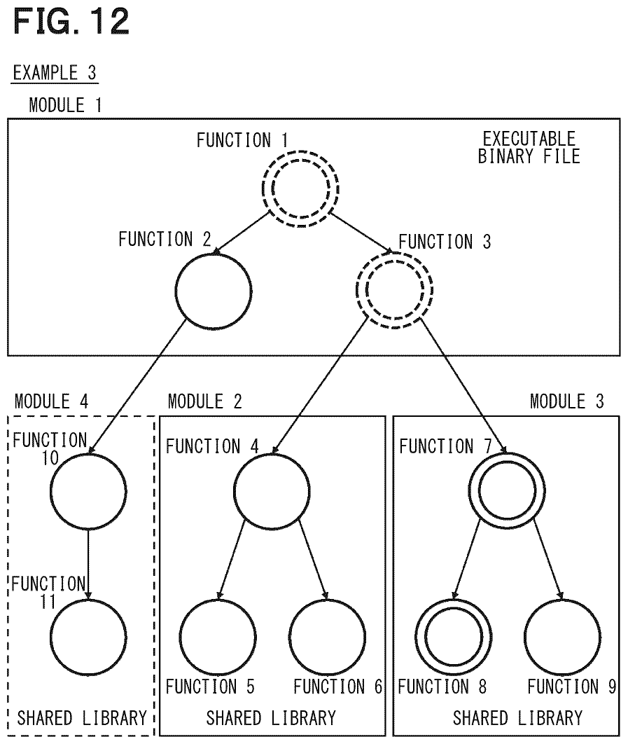

In FIG. 12, the function reachable to a function 7, which is the first function shown in FIG. 9, is a function 3. A function reachable to the function 3 is a function 1. In this example, the second identification unit 104 identifies functions 1 and 3 reachable to the function 7, which is a first function, as the second functions. Similarly, the functions reachable to a function 8, which is the first function shown in FIG. 9, are functions 1, 3, and 7. The second identification unit 104 identifies functions 1, 3, and 7 reachable to the function 8, which is the first function, as the second functions.

If the first information stored in the storage unit 108 is FIG. 4A, the second identification unit 104 identifies the sum of FIG. 10 to FIG. 12, that is, functions 1, 3, 4, and 7 as the second functions.

Returning to FIG. 3, the application scope determination unit 105 determines the scope of application of Control Flow Integrity (CFI) including the first function identified by the first identification unit 103 and the second function identified by the second identification unit 104 according to the type of control flow. In this embodiment, the application scope determination unit 105 determines the scope of application of CFI based on the second information stored in the storage unit 108 according to the type of control flow extracted by the extraction unit 102.

In the embodiment, the second information stored in the storage unit 108 is assumed to be FIG. 5A. In this case, if the target control flow is Forward Edge, a function included in the entire module containing at least one of the first or second functions is the scope of target functions. If the target control flow is Backward Edge, the first and second functions is the scope of target functions. In other words, in this case, the scope of application of CFI when the type of control flow is Backward Edge is narrower than the scope of application of CFI when the type of control flow is Forward Edge. The details of the step of determining the scope of application of CFI by the application scope determination unit 105 will be described with reference to FIG. 13 to FIG. 15.

FIG. 13 illustrates the step of determining the scope of application of CFI in the example shown in FIG. 7 and FIG. 10. The function 5 identified as the first function by the first identification unit 103 includes a process that writes to memory, and the type of control flow corresponds to Backward Edge. In an attack against Backward Edge, the return address in the stack frame is rewritten before the return is executed. Therefore, if an attacker attacks the function 5, the return addresses that the function 5 can tamper with are the calling functions 1, 3, and 4, indicated by bold arrows in FIG. 13. Therefore, the application scope determination unit 105 determines the scope of application of CFI to include the function 5 identified as the first function by the first identification unit 103 and the functions 1, 3, and 4 identified as the second functions by the second identification unit 104. In FIG. 13 to FIG. 15, the scope of application of CFI is indicated by double dashed rectangles.

An example method of applying CFI to arbitrary functions within a module rather than the entire module is to apply it to the entire module while including all unmarked functions in an exclusion list (Clang-CFI blacklist).

Thus, by determining the scope of application of CFI to include the first and second functions when the type of control flow is Backward Edge, it is possible to achieve secure protection against attacks on Backward Edge with minimal application of CFI.

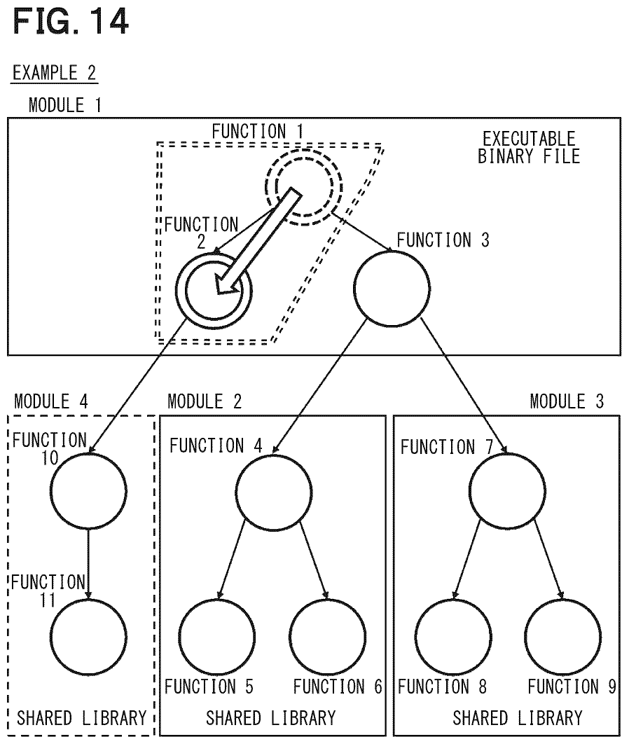

FIG. 14 illustrates the step of determining the scope of application of CFI in the example shown in FIG. 8 and FIG. 11. The function 2 identified as the first function by the first identification unit 103 includes a process that calls a module not protected by CFI, and the type of control flow corresponds to Backward Edge. For the same reasons as in FIG. 13, the application scope determination unit 105 determines the scope of application of CFI to include the function 2 identified as the first function by the first identification unit 103 and the function 1 identified as the second function by the second identification unit 104.

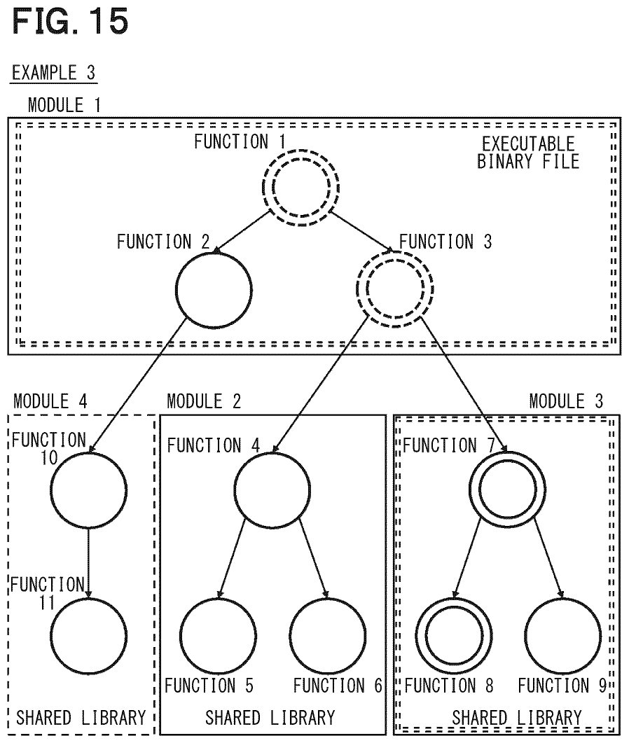

FIG. 15 illustrates the step of determining the scope of application of CFI in the example shown in FIG. 9 and FIG. 12. The functions 7 and 8 identified as the first functions by the first identification unit 103 include processes that serve as the starting point for function calls, and the type of control flow corresponds to Forward Edge. In an attack against Forward Edge, the value pointed to by the function pointer is rewritten before executing the indirect call, and the function pointer may be placed in a global area of the address space. Therefore, it may be desirable for the scope of application of CFI to include not only the calling functions but also the entire module containing the first and second functions. Therefore, in FIG. 15, the application scope determination unit 105 determines the scope of application of CFI to include the entire module 1 containing the functions 1 and 3 identified as the second functions by the second identification unit 104, and similarly, the entire module 3 containing functions 7 and 8 identified as the first functions by the first identification unit 103. This means that the functions 2 and 9 are also within the scope of application of CFI.

Thus, when the type of control flow is Forward Edge, by determining the scope of application of CFI to include a module containing at least one of the first and second functions, it is possible to achieve more secure protection against an attack on Forward Edge.

When the second information stored in the storage unit 108 is FIG. 5A, the sum of FIG. 13 to FIG. 15, that is, the module 1 (these functions 1, 2, 3), the module 3 (these functions 7, 8, 9), and functions 4 and 5 corresponds to the actual scope of application of CFI.

Returning to FIG. 3, the insertion unit 106 inserts the processing instruction stored in the storage unit 108 into the program code within the scope of application determined by the application scope determination unit 105. Specifically, a processing instruction corresponding to the type of control flow, Forward Edge or Backward Edge in this embodiment, is inserted into the functions within the determined scope of application. The step of inserting a processing instruction will be described with reference to FIG. 16 and FIG. 17.

First, FIG. 16 shows an example of inserting a processing instruction when the type of control flow is Backward Edge. In the scope of application determined by the application scope determination unit 105, for example, in these functions 1, 3, 4, and 5 shown in FIG. 13, code to protect the return address is inserted at the entry and exit of each function. In FIG. 16, a processing instruction 1 is inserted at the entry, and a processing instruction 2 is inserted at the exit.

The inserted code may vary depending on the verification method. Any code can be used depending on the solution. An example of the inserted code is the Stack Smashing Protector (SSP), which inserts a marker (Canary) into a stack frame and detects tampering as an anomaly when the marker is altered immediate before the return. SSP may be particularly effective against a stack buffer overflow attack. Another example of the inserted code is ShadowCallStack (LLVM/Clang), which stores the return address in a memory area different from a normal stack area (PUSH/POP) to detect an attack by an attacker. By using such a code, when a process that is inconsistent with the transition destination is performed, it is possible to detect the destination is an illegal transition destination and stop the branch instruction from being executed.

Next, FIG. 17 shows an example of inserting a processing instruction when the type of control flow is Forward Edge. In the scope of application determined by the application scope determination unit 105, for example, in these functions 1, 2, 3 of the module 1 and these functions 7, 8, 9 of the module 3 shown in FIG. 15, code to verify whether the transition destination is legitimate is inserted immediately before the branch instruction (blr/br) that these functions 1, 2, 3, 7, 8 and 9 have.

The inserted code may vary depending on the verification method. Any code can be used depending on the solution. In the example shown in FIG. 17, a processing instruction 3 is inserted immediately before the indirect call to verify the transition destination. The processing instruction to be inserted is, for example, a code that predefines the address of a legitimate transition destination and checks whether the transition destination specified as the transition destination matches, or a code that predefines the type of functions allowed as transition destinations (e.g., return type, combination of argument types) and checks whether the type of the specified transition destination function matches. By using such a code, when a process that is inconsistent with the transition destination is performed, it is possible to detect the destination is an illegal transition destination and stop the branch instruction from being executed.

Returning to FIG. 3, the output unit 107 may output the program including the program code with the inserted processing instructions by the insertion unit 106 to an external device. An example of the output destination is the electronic control device 20, where the program with the inserted processing instructions is written into the memory or other storage of the electronic control device 20 during output.

According to the program generation device of the embodiment, by determining the scope of application of CFI according to the type of control flow, it is possible to suppress the overhead during program execution while using CFI technology. This enables implementation on low-performance processors. Additionally, according to the program generation device of the embodiment, since the scope of application of CFI differs for Backward Edge and Forward Edge control flows, it is possible to set the optimal scope of application of CFI according to the type of control flow.

### 4. Second Embodiment (Program Generation Device 200)

In the first embodiment, the first identification unit 103 and the application scope determination unit 105 automatically generates a program including program code with inserted processing instructions based on the first information and second information stored in the storage unit 108. Considering the diverse attack patterns of various attackers, the present disclosure is also applicable when the program creator manually inserts processing instructions into the appropriate scope while recognizing the functions and control flow. Therefore, in this embodiment, a program generation device 200 will be described, in which the program creator can manually input the first information and second information in some processes of program generation.

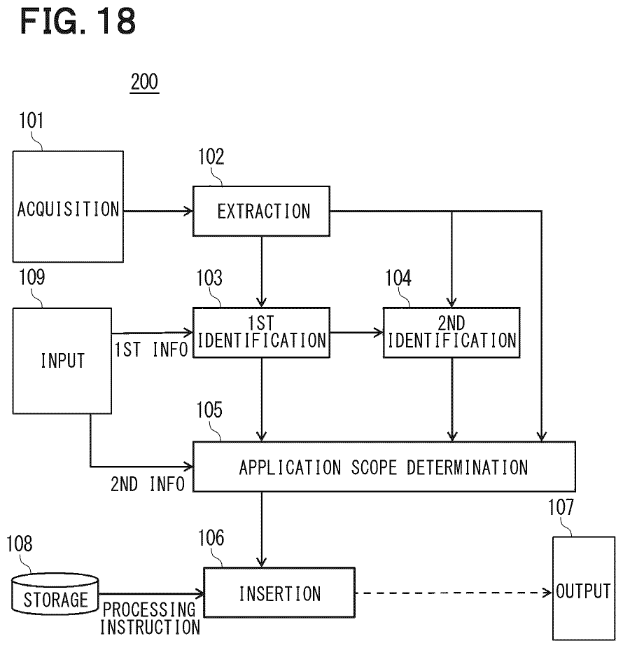

An example configuration of the program generation device 200 of this embodiment will be described with reference to FIG. 18. The program generation device 200, compared to the configuration of the first embodiment shown in FIG. 3, includes an input unit 109 instead of the storage unit 108. Hereinafter, blocks and functions common to the first embodiment are assigned the same numerals as the blocks in the first embodiment, and the description of the first embodiment is referenced.

The input unit 109 allows, for example, the program creator to input the first information regarding processes with a high tampering likelihood in the control flow. The inputted first information is provided to the first identification unit 103. The first identification unit 103 identifies the first functions based on the first information inputted from the input unit 109.

Similarly, the input unit 109 allows, for example, the program creator to input the second information defining the control flow to which CFI is to be applied and the scope of functions to which CFI is to be applied. The inputted second information is provided to the application scope determination unit 105. The application scope determination unit 105 determines the scope of application of CFI based on the second information inputted from the input unit 109 according to the type of control flow extracted by the extraction unit 102.

In the above example, it is assumed that the input to the input unit 109 is made by the program creator, but the input may also be made without involving the program creator. For example, the first information and second information transmitted from a device other than the program generation device 200 may be inputted.

### 5. Overall

The features of the program generation method and other aspects of the present disclosure in each embodiment have been described.

The block diagram used for the description of each embodiment is obtained by classifying and arranging the configuration of the device by function. The blocks representing the respective functions may be implemented by any combination of hardware or software. Since the blocks represent the functions, such a block diagram may also be understood as disclosures of a method and a program for implementing the method.

The order of the functional blocks that can be understood as the processing, the flow, and the method described in each embodiment may be changed unless there are restrictions, such as a relationship in which one step uses the result of another step in the preceding step.

The terms such as first, second, to N-th (where N is an integer) used in each embodiment and in the disclosure are used to distinguish two or more configurations and methods of the same kind and are not intended to limit the order or superiority.

Examples of the forms of the program generation device and the electronic control device of the present disclosure include the following. Examples of the form of the component include a semiconductor element, an electronic circuit, a module, and a microcomputer. Examples of the forms of semi-finished products includes system boards. Examples of the forms of finished products include a mobile phone, a smartphone, a tablet, a personal computer (PCs), a workstation, and a server. In addition, devices with communication functions, and the like are included, and examples thereof include a video camera, a still camera, and a car navigation system.

Additionally, necessary functions such as antennas and communication interfaces may be added to the program generation device and the electronic control device.

The device can be implemented not only by dedicated hardware having the configurations and functions described in the embodiments, but also by a combination of a program, which is recorded on a storage medium such as a memory or a hard disk and is used for implementing the above configuration and features, and general-purpose hardware that has a dedicated or general-purpose CPU that can execute the program, a memory, and the like.

A program stored in a non-transitory tangible storage medium (for example, an external storage device (a hard disk, a USB memory, and a CD/BD) of dedicated or general-purpose hardware, or an internal storage device (a RAM, a ROM, and the like)) may also be provided to dedicated or general-purpose hardware via the storage medium or from a server via a communication line without using the storage medium. As a result, it is possible to always provide the latest functions through program upgrade.

The program generation device and the electronic control device of the present disclosure are not limited to an in-vehicle application. That is, both devices can be used in in-vehicle applications, or either one can be used in-vehicle, or neither device can be used in-vehicle.

What is claimed is:

1. A program generation method comprising:
acquiring a program;
extracting functions within program code included in the program and a control flow, which is a call/return relationship of the functions;
identifying a first function among the functions that has a high tampering likelihood in the control flow;
identifying a second function among the functions that is reachable to the first function;
determining a scope of application of control flow integrity (CFI) including the first function and the second function according to a type of the control flow; and
inserting a processing instruction into the program code to execute the control flow correctly within the scope of application.

2. The program generation method according to claim 1, wherein
in a case where the type is a backward edge, the first function and the second function are determined as the scope of application.

3. The program generation method according to claim 1, wherein
in a case where the type is a forward edge, a module including at least one of the first function and the second function is determined as the scope of application.

4. The program generation method according to claim 1, wherein
processing with a high tampering likelihood includes at least one of (i) processing that rewrites a memory or an address on the memory, or (ii) processing that invokes a module outside the scope of application of CFI.

5. The program generation method according to claim 1, wherein
processing with a high tampering likelihood includes at least one of (i) processing that transitions control by referring to an address on a memory, or (ii) processing that is placed at an address stored in the memory as a transition destination.

6. The program generation method according to claim 1, wherein
the processing instruction includes check processing instruction that checks whether the control flow is executed correctly or protection processing instruction that protects the control flow.

7. The program generation method according to claim 1, further comprising
installing into an electronic control device the program including the program code with the processing instruction inserted.

8. A program generation device comprising:
an acquisition unit configured to acquire a program;
an extraction unit configured to extract functions within program code included in the program and a control flow, which is a call/return relationship of the functions;
a first identification unit configured to identify a first function among the functions that has a high tampering likelihood in the control flow;
a second identification unit configured to identify a second function among the functions that is reachable to the first function;
an application scope determination unit configured to determine a scope of application of control flow integrity (CFI) including the first function and the second function according to a type of the control flow; and
an insertion unit configured to insert processing instruction into the program code to execute the control flow correctly within the scope of application.

9. The program generation device according to claim 8, further comprising
a storage unit configured to store first information regarding processing with a high tampering likelihood,
wherein
the first identification unit identifies the first function based on the first information.

10. The program generation device according to claim 8, further comprising
an input unit configured to input first information regarding processing with a high tampering likelihood,
wherein
the first identification unit identifies the first function based on the first information.

11. The program generation device according to claim 8, further comprising
a storage unit configured to store second information defining the control flow to which CFI is to be applied and the scope of functions to which CFI is to be applied,
wherein
the application scope determination unit determines the scope of application based on the second information according to the type of the control flow extracted by the extraction unit.

12. The program generation device according to claim 8, further comprising
an input unt configured to input second information defining the control flow to which CFI is to be applied and the scope of functions to which CFI is to be applied,
wherein
the application scope determination unit determines the scope of application based on the second information according to the type of the control flow extracted by the extraction unit.

13. A non-transitory computer readable storage medium storing a program generation program executable by a program generation device, wherein the program generation program executes the program generation method according to claim 1.

14. A non-transitory computer readable storage medium storing a program generated by the program generation method according to claim 1.

15. An electronic control device in which the program generated by the program generation method according to claim 1 is installed.
